(19) United States
(12) Patent Application Publication
(10) Pub. No.: US 2006/0092851 A1
(43) Pub. Date: May 4, 2006

(54) Method and apparatus for communicating predicted future network requirements of a data center to a number of adaptive network interfaces

(76) Inventors: Jeffrey Forrest Edlund, Lees Summit, MO (US); David George Thomson, Overland Park, KS (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,957

(22) Filed: Oct. 29, 2004

(51) Int. Cl. H04J 3/14; H04J 1/16; H04L 1/00; H04L 12/26; H04L 12/66

(52) U.S. Cl. 370/252; 370/229

(57) ABSTRACT

In one embodiment, machine-readable media has stored thereon sequences of instructions that, when executed by a number of machines, cause the machine(s) to monitor behavior of a data center; acquire network utilization data; correlate the network utilization data with the data center behavior; store results of the correlations as trend data; utilize the data center behavior and trend data to predict future network requirements of the data center; and communicate the predicted future network requirements to a number of adaptive network interfaces.

### BACKGROUND

A data center is a collection of secure, fault-resistant resources that are accessed by users over a communications network (e.g., a wide area network (WAN) such as the Internet). By way of example only, the resources of a data center may comprise servers, storage, switches, routers, or modems. Often, data centers provide support for corporate websites and services, web hosting companies, telephony service providers, internet service providers, or application service providers.

Some data centers, such as Hewlett-Packard Company's Utility Data Center (UDC), provide for virtualization of the various resources included within a data center.

### SUMMARY OF THE INVENTION

In one embodiment, machine-readable media has stored thereon sequences of instructions that, when executed by a number of machines, cause the machine(s) to monitor behavior of a data center; acquire network utilization data; correlate the network utilization data with the data center behavior; store results of the correlations as trend data; utilize the data center behavior and trend data to predict future network requirements of the data center; and communicate the predicted future network requirements to a number of adaptive network interfaces.

Other embodiments are also disclosed.

### BRIEF DESCRIPTION OF THE DRAWINGS

Illustrative embodiments of the invention are illustrated in the drawings, in which:

FIG. 1 illustrates a method for communicating predicted future network requirements of a data center to a number of adaptive network interfaces;

FIGS. 2-4 illustrate various functional views of an exemplary data center to which the FIG. 1 method may be applied; and

FIG. 5 illustrates the connection of two different data center locations to a network.

### DETAILED DESCRIPTION OF AN EMBODIMENT

Monitoring the performance of one or several WAN connections is an important task in network management. Network performance monitoring allows network administrators and routing systems to identify potential network problems and evaluate network capacity and efficiency. In current network management systems, the information on which network management decisions are based is gathered at the edge devices of the network, and is predicated on what is going on in the network at the time of collection. However, network management decisions could be better optimized if they were to take into account behaviors that are external to the network. This is especially so for data centers.

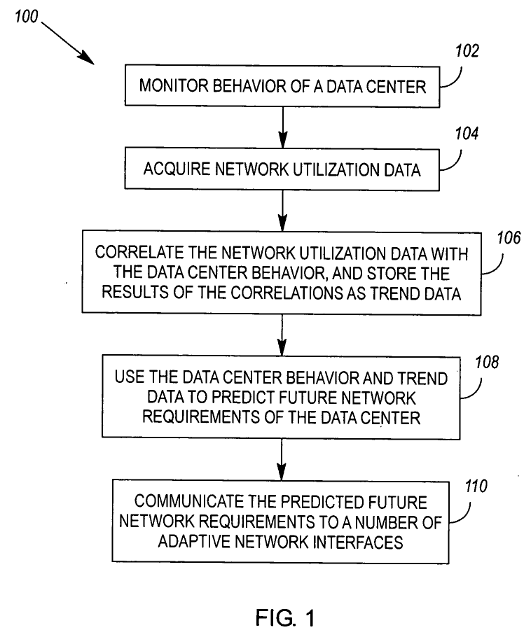

Consider, for example, data synchronization events that need to occur between a data center and a remote site (e.g., as a result of backup or data recovery operations). Although the data synchronization events may be scheduled to occur at known, periodic intervals, there is currently no known mechanism for automatically and “proactively” provisioning network resources in advance of such data synchronization events. Rather, a network administrator may manually provision the network resources, or the network resources may be provisioned by a network management system “reactively” (i.e., after the network management system assesses that current network demands exceed the capabilities of currently provisioned network resources). FIG. 1 therefore illustrates a new method 100 for communicating predicted future network requirements of a data center to a number of adaptive network interfaces, thereby enabling the adaptive network interfaces to provision network resources proactively.

In accordance with the method 100, data center behavior is monitored 102 while acquiring 104 network utilization data. The network utilization data is then correlated 106 with the data center behavior, and results of the correlations are stored as trend data. The data center behavior and trend data are then used 108 to predict future network requirements of the data center 110. Finally, the predicted future network requirements are communicated to a number of adaptive network interfaces.

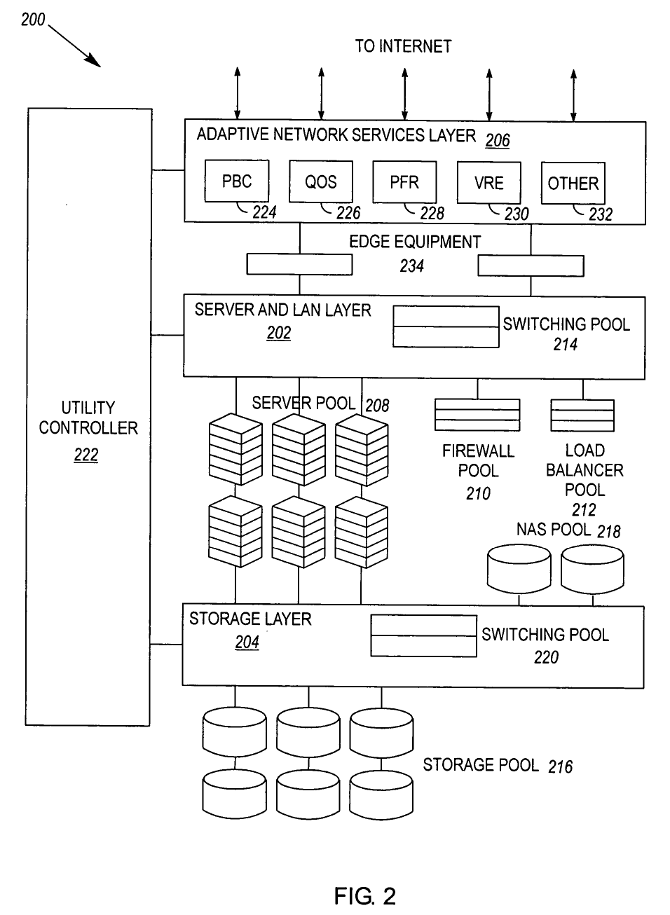

An exemplary data center 200 for which behavior may be monitored is shown in FIGS. 2-4. The data center 200 generally comprises a virtual server and local area network (LAN) layer 202, a virtual storage layer 204, and an adaptive network services layer 206 (see FIG. 2). The server and LAN layer 202 may comprise various resources, including a server pool 208, a firewall pool 210, a load balancer pool 212, a switching pool 214 and other components (e.g., routers). The storage layer 204 may also comprise various resources, including a storage pool 216, a network area storage (NAS) pool 218, a switching pool 220 and other components (e.g., direct attached storage (DAS), or a storage area network (SAN)). The components of the adaptive network services layer 206 will be described later in this description. Between the adaptive network services layer 206 and server and LAN layer 202 lies edge equipment 234 such as routers and switches.

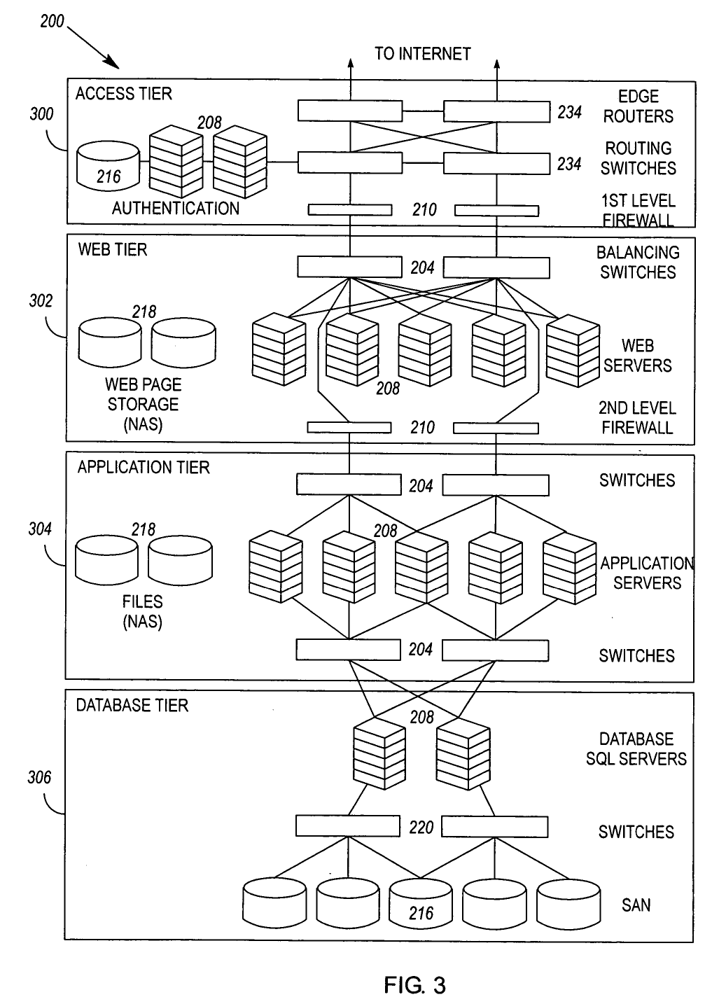

From the resources 208-220 of the server and LAN 202 and storage 204 layers, a utility controller 222 may form various tiers and partitions of resources. In one configuration of the data center's resources, a number of service tiers are formed, such as an access tier 300, a web tier 302, an application tier 304, and a database tier 306. See FIG. 3.

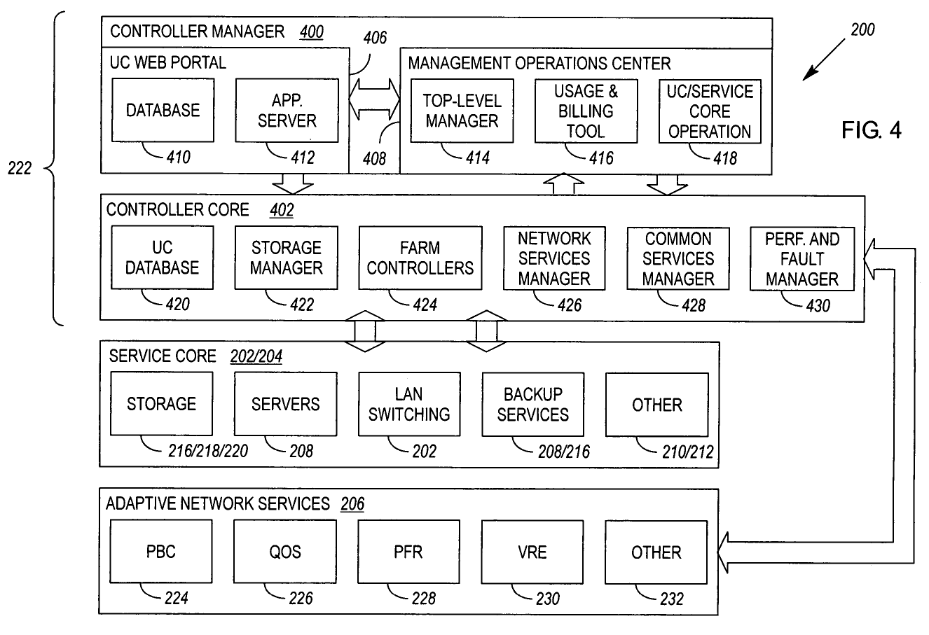

FIG. 4 illustrates further details of the utility controller 222. The utility controller 222 comprises a controller manager 400 and a controller core 402. The controller manager 400 comprises a utility controller (UC) web portal 404 and a management operations center 406. The UC web portal 404 comprises a web portal application server 408 (e.g., a Hewlett-Packard Company Bluestone Total-e-server) and a web portal database 410. Via the UC web portal 404, a user is presented a web interface for accessing, configuring and controlling the service core 202/204, 206 and administrative functions 400, 402 of the data center 200.

The management operations center 408 comprises a top-level manager 414, a data center usage and billing tool 416, and software 418 to interface with the utility controller core 402. In one embodiment, the top-level manager 414 is Hewlett-Packard Company's OpenView Manager of Managers (MOM), and the usage and billing tool 416 is the OpenView Internet Usage Manager (IUM). The software 418 that interfaces with the utility controller core 402 may variously comprise software to install and configure services, process faults, and gather performance and diagnostic information.

As shown, the utility controller core 402 comprises a UC database 420, a storage manager 422, a number of farm controllers 424, a network services manger 426, a common services manager 428, and a performance and fault manager 430. The UC database 420 stores resource information and a resource request queue. The storage manager 422 provides storage area network (SAN) configuration and management, and assists in backup and recovery operation management. The farm controllers 424 provide server configuration and management of “farm partitions”, and provide further assistance in backup and recovery operation management. As defined herein, a farm partition is merely a collection of resources (or parts of resources) that provides services to a particular data center client. The network services manager 426 provides WAN equipment management, configuration, control, switching and recovery. The common services manager 428 provides service core support for services such as Domain Name System (DNS) services, Trivial File Transfer Protocol (TFTP) services, Network Time Protocol (NTP), International Group for Networking, Internet Technologies, and eBusiness (IGNITE) services, and Dynamic Host Configuration Protocol (DHCP) services. The performance and fault manager 430 handles Simple Network Management Protocol (SNMP) polling and traps, configures performance and fault managing services, and re-provisions commands.

Having set forth one exemplary data center configuration 200, the operation of method 100 will now be described with respect to this data center 200. To begin, data center behavior is monitored 102 while acquiring 104 network utilization data. Although these actions may be performed more or less simultaneously, performing one action “while” performing the other action should also be construed to cover overlapping periodic performance of the two actions.

Data center behavior may be monitored by means of the network services manager 426, and the network services manager 426 may acquire network utilization data from the adaptive network services layer 206.

The monitored data center behavior may include various types of behavior, including, for example, server behavior, storage behavior, and/or application behavior. By way of example, server behavior may include processor usage, changes in server demand, rates of change in server demand, processor latency, server failures, and the movement of servers between farm partitions. Storage behavior may include such things as available storage capacity, storage activity (e.g., read/write demand), and storage failures. Application behavior may include the number of active applications, the types of active applications, the use of databases by applications, the locality of application data (e.g., is it within the data center 200), and the inferred or scheduled needs of applications (such as network-related needs, storage needs, or backup needs). Data center behavior may also be monitored at the controller or “administrative” level, and may include behavior such as scheduled processes of the data center 200 (e.g., backup and data synchronization events).

While some behaviors have a more or less direct impact on the network requirements of a data center 200, other behaviors may have an indirect or even speculative impact on the data center's network requirements. For example, the failure of a disk spindle in a redundant array of independent disks (RAID) configuration may lead to increased storage activity as storage requests go unfulfilled and are possibly reattempted. Although increased storage activity might often be an indirect indicator of a data center's need for increased network bandwidth, increased storage activity as a result of a disk failure may not be an indicator of such a need. If, however, the data that is on the failed disk needs to be retrieved from an offsite backup source, increased network bandwidth may be needed. As a result, a first monitored behavior (e.g., a disk failure) may at times be discounted in light of a second monitored behavior (e.g., the data on the failed disk is found elsewhere in the data center). Monitored behaviors that are deemed to be transient may also be discounted (e.g., increased storage activity as a result of a one-time configuration of a new database).

Monitored behaviors may be discounted by, for example, eliminating them from correlations with network utilization data, or correlating them with network utilization data and then noting that the behaviors have lesser impacts on the network utilization data with which they are correlated. By discounting certain data center behaviors, false identifications of increased data center needs can be reduced.

Similarly to how different types of data center behavior may be monitored, different types of network utilization data may also be acquired. For example, network utilization data may comprise the amount of network bandwidth that has been allocated to the data center 200, or various forms of quality of service (QOS) data (i.e., data indicating the extent to which network requirements are being met). In one embodiment of the method 100, network utilization data is acquired from network edge resources of the data center 200 (e.g., edge routers, switches and load balancers). However, it is also contemplated that network utilization data may be acquired from any source within a network.

Once obtained, the network utilization data is correlated 106 with the data center behavior, and results of the correlations are stored as trend data. In a simple case, this may simply comprise storing the data center behavior and network utilization data that exists at a particular point in time (or that existed within a certain window of time) in a table. However, the correlating may also be more advanced. For example, correlating the data may comprise relating changes in network utilization data to changes in data center behavior, or relating rates of change in network utilization data to rates of change in data center behavior.

With respect to the data center 200, correlations of data center behavior and network utilization data may be undertaken by the network services manager 426.

After compiling the trend data, the trend data and data center behavior are used 108 by the network services manager 426 to predict future network requirements of the data center 200. By way of example, the future network requirements may comprise requirements such as network bandwidth, QOS goals, and path failure and recovery preferences.

Finally, the predicted future network requirements are communicated 110 to a number of adaptive network interfaces 224, 226, 228, 230, 232. As shown in FIGS. 2 & 4, these interfaces 224-232 may comprise a predictive bandwidth control 224, a quality of service control 226, a path failure and recovery control 228, and a variable rating engine 230, as well as other controls 232.

As its name implies, the predictive bandwidth control 224 may process predicted future network requirements to ensure that network hardware is provisioned to support predicted bandwidth needs in a proactive manner. The network hardware with which the predictive bandwidth control 224 communicates may comprise routers, switches, load balancers, and communication channels that have been allocated (or are allocable) to the data center 200.

The QOS control 226 may process the predicted future network requirements to ensure that network service levels of routers, switches and network transport layers are maintained. The QOS control 226 may provide feedback to both the predictive bandwidth control 224 (so that the predictive bandwidth control 224 may also handle “reactive” bandwidth adjustments) and the variable rating engine 230.

The path failure and recovery control 228 provides a means for services and applications to subscribe to (and register for) network availability services. This control may also provide a means for monitoring network transport equipment to determine when path recovery operations need to be invoked. Under control of the data center 200, the path failure and recovery control 228 provides a means for self-healing the data center's connection(s) to a network.

The variable rating engine 230 receives information regarding predicted future network requirements so that it may pre-rate the requirements for customer billing purposes. The pre-rate information may then serve as a basis for pre-billing customers, or for notifying customers of what sort of billing they can expect. Feedback from the QOS control 226 can be used to revise billing information based on whether network requirements of the data center 200 (and, specifically, requirements of its various services and subscribed and registered applications) are actually met.

In addition to responding to predicted future network requirements of the data center 200, the adaptive network interfaces 224-232 may monitor network resources (e.g., both equipment and services) and pass information back to the utility controller 222 and data center services and registered applications that are executing within the data center 200. In addition to raw information, the information may comprise indications of the predicted success of meeting future network requirements. For example, if a predicted future network requirement is deemed to be excessive (i.e., beyond the capabilities of the resources that are available to be provisioned), this belief may be communicated to data center services and registered applications. In this manner, the affected services or applications may be able to adapt accordingly, which may include: making an attempt to reschedule an event, or notifying a client that the execution of a given activity may be delayed. Also, if a predicted future network requirement is deemed to be excessive, a service prioritization schedule may be used to allocate predicted available network services to data center services and applications. This information may then be communicated to the affected services and applications.

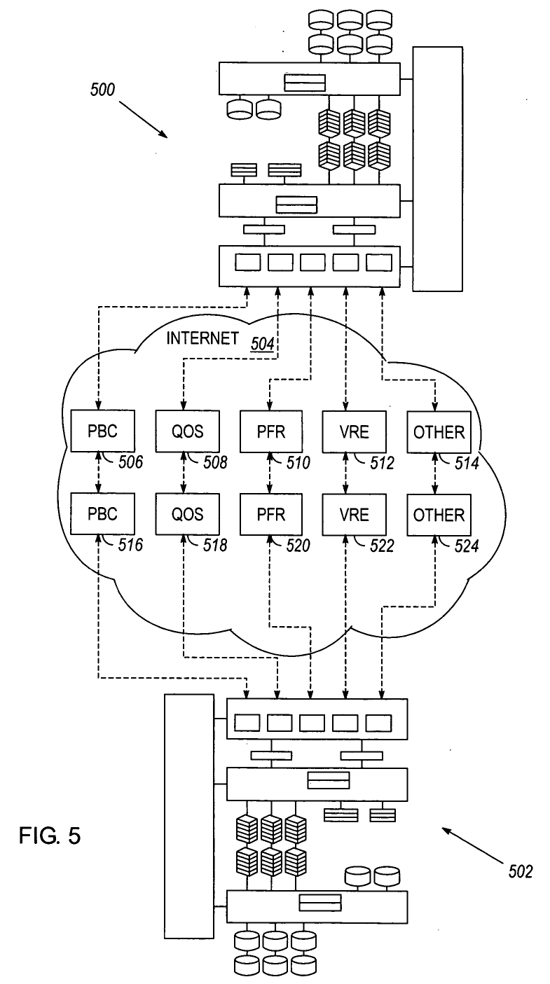

Although data centers are often centralized at discrete locations, there are times when a data center is distributed amongst two or more locations 500, 502 that are attached via a network 504 (see FIG. 5). Or, for example, the operations of two data centers 500, 502 may be so closely related (or dependent on each other), that the two data centers 500, 502 essentially appear to clients as a single, distributed data center (e.g., a virtual data center). In these situations, data center behavior may be monitored at each location 500, 502 of the distributed data center and then correlated with network utilization data. In this manner, behavior(s) at one data center location 500 may be correlated with behavior(s) at the other data center location 502, as well as with network utilization data for one or both of the data centers 500, 502. This may be useful in coordinating operations between the data center locations 500, 502.

FIG. 5 also illustrates the various network-related controls and services 506-524 that are influenced by their corresponding adaptive network interfaces within the data centers 500, 502.

Although FIG. 1 provides a method 100 for communicating predicted future network requirements of a data center to a number of adaptive network interfaces, the method 100 will typically be embodied in machine-readable media having sequences of instructions stored thereon. When executed by a number of machines (i.e., one or more machines), the sequences of instructions then cause the machine(s) to perform the various actions of the method 100. By way of example, the instructions may take the form of software or firmware contained within a single disk or memory, or the instructions may take the form of code that is distributed amongst (and executed by) various hardware devices.

What is claimed is:

1. Machine-readable media having stored thereon sequences of instructions that, when executed by a number of machines, cause the machine(s) to perform the actions of:
monitoring behavior of a data center;
acquiring network utilization data;
correlating said network utilization data with said data center behavior, and storing results of said correlations as trend data;
utilizing said data center behavior and trend data to predict future network requirements of the data center; and
communicating said predicted future network requirements to a number of adaptive network interfaces.

2. The machine-readable media of claim 1, wherein said network utilization data is acquired from network edge resources of the data center.

3. The machine-readable media of claim 1, wherein said correlating comprises relating changes in network utilization data to changes in data center behavior.

4. The machine-readable media of claim 1, wherein said correlating comprises relating rates of change in network utilization data to rates of change in data center behavior.

5. The machine-readable media of claim 1, wherein the monitored behavior of the data center comprises scheduled processes.

6. The machine-readable media of claim 1, further comprising, discounting a first monitored behavior in light of a second monitored behavior.

7. The machine-readable media of claim 1, further comprising, discounting monitored behaviors that are deemed to be transient.

8. The machine-readable media of claim 1, further comprising, if a predicted future network requirement is deemed to be excessive, communicating this belief to data center services and registered applications.

9. The machine-readable media of claim 1, further comprising, if a predicted future network requirement is deemed to be excessive, allocating predicted available network services to data center services and registered applications, in accordance with a service prioritization schedule.

10. The machine-readable media of claim 9, further comprising, if predicted available network services are allocated to data center services in accordance with said service prioritization schedule, communicating this to data center services and registered applications whose network requirements are unlikely to be met.

11. The machine-readable media of claim 1, wherein said network requirements comprise network bandwidth.

12. The machine-readable media of claim 1, wherein said adaptive network interfaces govern communication channels allocated to the data center.

13. The machine-readable media of claim 1, wherein said network utilization data comprises network bandwidth allocated to the data center.

14. The machine-readable media of claim 1, wherein said network utilization data comprises quality of service data.

15. The machine-readable media of claim 1, wherein said monitored behavior of the data center comprises server behavior.

16. The machine-readable media of claim 1, wherein said monitored behavior of the data center comprises storage behavior.

17. The machine-readable media of claim 1, wherein said monitored behavior of the data center comprises application behavior.

18. The machine-readable media of claim 1, wherein said adaptive network interfaces comprise a quality of service control.

19. The machine-readable media of claim 1, wherein said adaptive network interfaces comprise a path failure and recovery control.

20. The machine-readable media of claim 1, wherein said data center is distributed amongst two or more locations attached to said network for which network utilization data is acquired, and wherein data center behavior monitored at each location of said distributed data center is correlated with said network utilization data.

21. The machine-readable media of claim 1, wherein said adaptive network interfaces comprise a variable rating engine to pre-rate said predicted future network requirements for customer billing purposes.

22. A system, comprising:
a number of adaptive network interfaces to:
monitor network resources; and
provision network services; and
a data center comprising a network services manager to:
monitor behavior of a data center;
acquire network utilization data from said at least one adaptive network interface;
correlate said network utilization data with said data center behavior, and store results of said correlations as trend data;
utilize said data center behavior and trend data to predict future network requirements of the data center; and
communicate said predicted future network requirements to said number of adaptive network interfaces.

23. Apparatus, comprising:
means for correlating network utilization data with the behavior of a data center;
means for, in response to the correlating means and current data center behavior, predicting future network requirements of the data center; and
means for communicating said predicted future network requirements to adaptive network interface means.
